(19) United States
(12) Patent Application Publication
(10) Pub. No.: US 2005/0076103 A1
(43) Pub. Date: Apr. 7, 2005

(54) Real time web session affinity identification and user bonding

(75) Inventors: Bill H. Hilf, La Habra, CA (US); Neil A. Katz, Parkland, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/667,741

(22) Filed: Sep. 22, 2003

(51) Int. Cl. G06F 15/177

(52) U.S. Cl. 709/220

(57) ABSTRACT

A method, system and machine readable storage for creating user groups in a network environment. The method includes the step of monitoring a plurality of user sessions, each associated with a different user. At least one affinity among the user sessions can be identified. Responsive to the affinity identification, at least one action can be initiated, for example, presenting a user interface to at least one of the users and/or prompting users to engage in communication.

### BACKGROUND OF THE INVENTION

1. Technical Field

This invention relates to the field of networking, and more particularly to processing of session information.

2. Description of the Related Art

Use of the Internet has become ubiquitous throughout much of the world, linking together a myriad of resources and making these resources available to Internet users. Accordingly, Internet users access the Internet to communicate, perform electronic research, conduct commercial transactions, and perform a variety of other tasks. Such Internet usage can be conducted from the privacy of a home, an office, or any other location having an Internet connection.

Although the Internet electronically links resources together for the above mentioned purposes, oftentimes Internet usage lacks personal interaction. For example, when evaluating the purchase of consumable goods over the Internet, there typically is not anyone available with whom a consumer can communicate in real time regarding the purchase. Hence, what is needed is a method for facilitating real time communications for Internet users having a shared interest.

### SUMMARY OF THE INVENTION

The invention disclosed herein relates to a method for creating user groups in a network environment. The method includes the step of monitoring a plurality of user sessions, each associated with a different user. At least one affinity among the user sessions can be identified. Responsive to the affinity identification, a plurality of users can be prompted to engage in communication. For example, users can be provided access to an interaction application. The interaction application can establish a communication pathway between user sessions to facilitate real time communications between users. For instance, the interaction application can include a chat session, an instant messaging session, a newsgroup, and/or a shared application. In another arrangement, a user interface can be presented to at least one user in response to the affinity identification.

Session cookies and session objects associated with the user sessions can be evaluated to identify affinities. The session objects can include at least one datum, such as a URL which has been accessed, an amount of time on-line, an item in a shopping cart, and/or a user identifier. The user identifier could include information such as a postal code, an area code, a city, a county, a state, a province, a country and/or a continent.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system in accordance with the inventive arrangements disclosed herein.

FIG. 2 is a flow chart illustrating a method in accordance with the inventive arrangements disclosed herein.

FIG. 3 is a flow diagram illustrating an exemplary application of the system of FIG. 1 in accordance with the inventive arrangements disclosed herein.

### DETAILED DESCRIPTION OF THE INVENTION

An embodiment in accordance with the present invention relates to a method for creating a link between user sessions in real time responsive to affinities being identified among the user sessions. In particular, one or more affinities can be identified among a plurality of user sessions. In response, a user interface can be presented to the users and/or prompt the users to engage in conversation. For example, if multiple users are currently viewing a web page containing merchandise, a user interface can be presented to the users offering a discount if a specified number of users purchase a product which is shown on the web page within a certain amount of time. In another arrangement, a communication pathway can be established between the users. For example, the users having identified affinities can be provided access to an interaction application to establish a communication session, such as a chat session or instant messaging session, can be opened. The users can use the communication session to communicate with each other. For instance, the users can comment on the products shown on the web page.

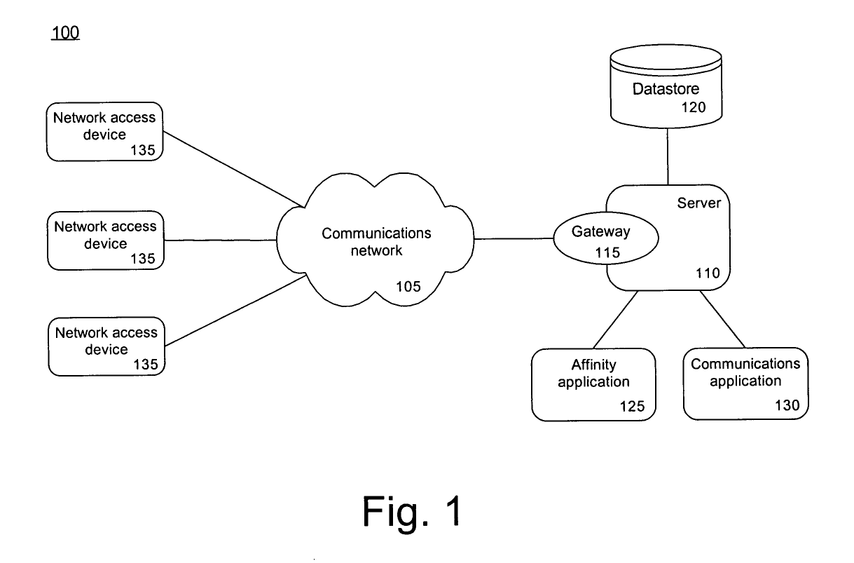

Referring to FIG. 1, a schematic diagram is shown of a system 100 enabling a link to be established between user sessions in real time responsive to affinities being identified among the user sessions. As depicted, the system 100 can include a communications network 105, a server 110, a gateway 115, a datastore 120, an affinity application 125, a communications application 130, and various network access devices 135.

The communications network 105 can include, for example, a local area network, a wide area network, and/or the Internet. The communications network 105 can communicatively link the various computing components that form the network environment of the system 100. The communications network 105 can utilize any communication medium to facilitate information exchange within the network environment including, but not limited to, wireless pathways, line-based pathways, satellite pathways, and line-of site pathways. Moreover, the communications network 105 can include global networks, local networks, and stand-alone computing devices. For example, the communications network 105 can include the Internet, intranets, and other sub-networks. Additionally, the communications network 105 can include mainframes, personal computers, personal data assistants, cellular telephones, land-based telephones, networked peripherals, and other hardware. Communication over the communications network 105 can be based upon any communication methodology through which information can be exchanged including, but not limited to, packet-switched and circuit-switched methodologies.

The network access devices 135 can be any devices which enable users to access the communications network 105 and communicate with the server 110. For example, the network access devices 135 can be general purpose computers, computer terminals, personal digital assistants, or any other network device having a user interface, including but not limited to, wireless telephones.

The server 110 can be operatively connected to the communications network 105. The server 110 can be any computer program residing on a computer that provides services to other computer programs. For example, the server 110 can provide services to programs operating in network access devices 135. Moreover, the server 110 can provide services to programs operating on the same computer on which the server resides, for example affinity application 125 and communications application 130. In one arrangement, the affinity application 125 and/or the communications application 130 can reside within the server 110, for example as modules or applications running within the server space itself, as referenced objects, or in any other manner in which an application can be incorporated into a server.

The server can communicate over the communications network 105 via the gateway 115. The gateway 115 can be a network point that acts as an entrance to another network. For example, the gateway 115 can act as an interface between the server 110 and the communications network 105. The gateway 115 can be associated with a router, which knows where to direct a given packet of data that arrives at the gateway, or a switch, which furnishes the actual path in and out of the gateway 115 for a given packet. In some arrangements, however, the gateway 115 may not be required, for example where the server communicates only with a single network.

The server 110 also can access the datastore 120 to interface with software applications and/or for data storage and retrieval. The datastore 120 can be implemented as a storage device which can store applications and/or data relating to user sessions. For example, the datastore 120 can comprise a magnetic storage medium, an optical storage medium, a magneto-optical storage medium, an electronic storage medium, or any other data storage device.

The affinity application 125 can be executable software or firmware which can evaluate session objects and identify affinities among user sessions. As defined herein, an affinity is a similarity between two or more user sessions. An affinity can be determined by identifying similarities or relationships between one or more predetermined attributes relating to, or describing, user sessions. The affinities can have multiple contexts. For instance, affinities can be identified in session level data elements, session structural similarities, session-based user profile relationships, or common origins, such as common web link pathways. Still, the invention is not so limited and affinities can be identified using other methods. For example, the affinity application 125 can evaluate session cookies of multiple user sessions. The affinity application 125 can further identify a key within each session cookie which identifies user session data located on the server side of the user session, such as session data stored on the datastore 120. The session cookies and/or session data can be evaluated by the affinity application 125 to identify similarities between two or more user sessions. For example, the affinity application 125 can identify a specific URL which has been accessed in multiple user sessions, a minimum or maximum amount of time spent on-line by a plurality of users, an item common in shopping carts of multiple users, or a user identifier which can associate a user with other users. For instance, the affinity application can identify multiple users from a same postal code, area code, city, county, state, province, country and/or continent.

The session objects and session data which are evaluated can be associated with currently active user sessions. In particular, session cookies can expire when a user session with which the session cookie is associated is closed, for instance, when a browser operating with a particular network access device 135 is closed. Further, session data stored on the server side of the user session, for example on datastore 120, can be deleted when the user session is closed. Alternatively, the data can be identified as being associated with a closed user session. Accordingly, such data can be ignored by, or otherwise made unavailable to, the affinity application 125 when the affinity application 125 is identifying affinities in current user sessions.

The communications application 130 can establish a communication link between the server and user sessions and/or establish a communication link among multiple user sessions. For example, the communications application 130 can send a prompt to a user and/or receive user inputs. The prompt can be an audio and/or a visual prompt. For example, a user interface, for instance a window which is displayed in the user's browser, can be presented to a user. The window can contain a message to the user, such as a message to which the user can respond. The message also can provide information pertaining to other users who have a shared affinity. For example, if a user is retrieving information on a particular piece of merchandise, the message can inform the user of how many other users currently have similar merchandise in their shopping carts.

The communications application 130 also can provide to multiple users, for instance those having a shared affinity, access to an interaction application. The interaction application can be an application which facilitates user interaction with the server and/or facilitates communication among multiple users. For example, the interaction application can include a chat session, an instant messaging session, a newsgroup, and/or a shared application which can be opened to establish a communication pathway between user sessions having one or more identified affinities. For example, users can use the interaction application to share comments regarding particular merchandise. Users can be provided a message asking them if they wish to participate in a communication session with other users prior to the communication pathway being established. The communications application 130 can receive a response from the user replying to the message and respond accordingly.

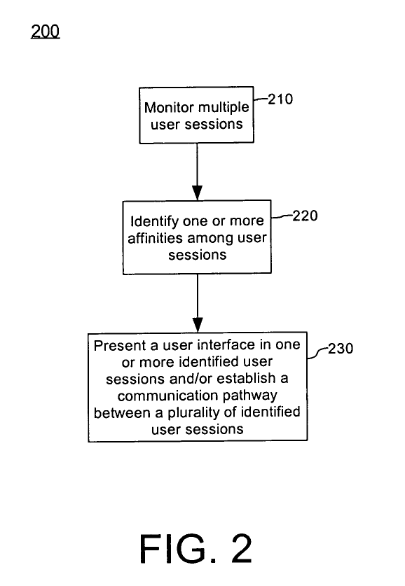

A flow chart 200 illustrating operation of the system is shown in FIG. 2. Referring both to FIGS. 1 and 2, the affinity application 125 can monitor multiple user sessions established between the network access devices 135 and the server 110, as shown in step 210. The affinity application 125 can identify affinities among user sessions, as shown in step 220. Continuing to step 230, after the affinity application 125 has identified affinities between user sessions, the communications application 130 can send a prompt to at least one of the users. For example, the communications application forward a message to the user and provide information pertaining to other users who have a shared affinity. As noted, the communications application 130 also can forward an interaction application to multiple users having a shared affinity.

In one arrangement, the communications application 130 can send an alert to system, security, and/or network administrators in the instance that an error or abnormal user behavior is detected. In particular, rules or policies can be implemented to establish boundary conditions where certain types of affinities can initiate the alerts. For example, the affinities can be used to identify abnormal shopping conditions. For instance, if a traditionally low volume and high priced item appears in a large number of shopping carts, an alert can be sent to an administrator to verify whether the item pricing is correct and/or whether the item is being overly discounted. Further, the affinities can be used identify fraud in real time. For example, the affinities can be used to identify a circumstance where an abnormally high number of users are using a particular discount code, an unusually high number of users are located in a same geographic region, multiple users are using a same credit card number, or any other condition which can be indicative of user fraud.

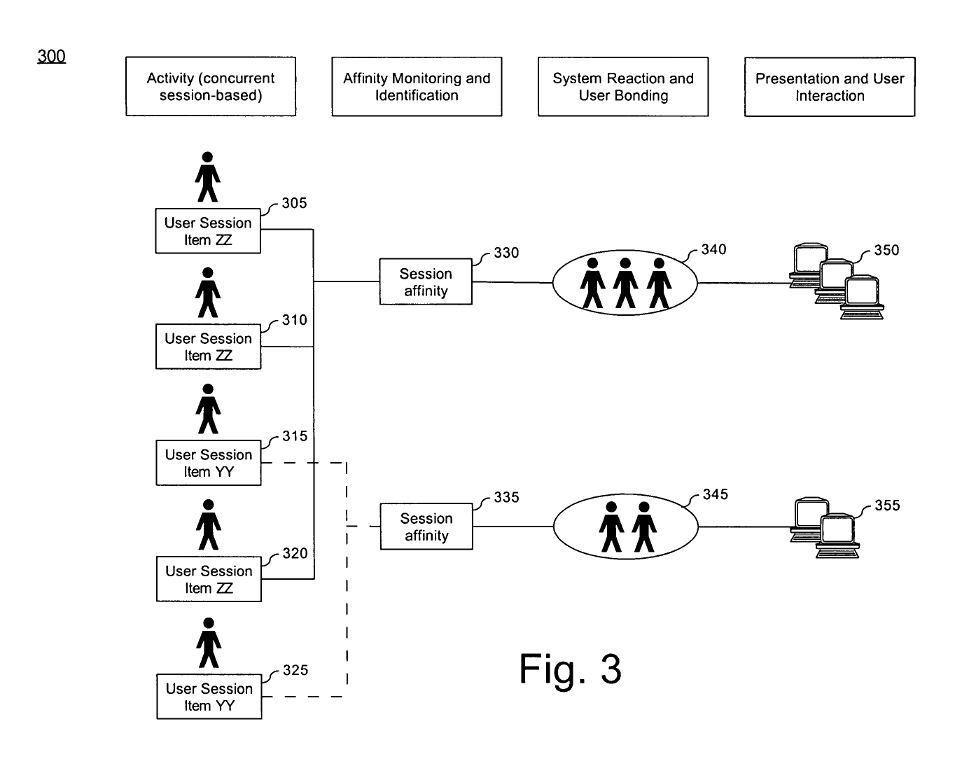

Referring to FIG. 3, a flow diagram 300 illustrating an exemplary application of the system of FIG. 1 is shown. In the flow diagram 300, multiple user sessions can be opened, for example user sessions 305, 310, 315, 320, 325. In this example, users in user sessions 305, 310, 320 have concurrently accessed a URL address containing information on item ZZ. Further, users in user sessions 315, 325 have concurrently accessed a URL address containing information on item YY. The URL addresses that have been concurrently accessed in multiple user sessions can be identified as session affinities. For instance, a session affinity 330 can be identified for user sessions in which the URL address for item ZZ has been concurrently accessed. A session affinity 335 also can be identified for user sessions in which the URL address for item YY has been concurrently accessed. The affinity application can group the user sessions into user groups responsive to the identification of the affinities. For instance, user group 340 can be formed for the user sessions sharing the session affinity 330, and user group 345 can be formed for the user sessions sharing the for the session affinity 335.

A user interface 350 then can be presented to each user in group 340, for instance, to ask users whether they wish to participate in a chat session pertaining to item ZZ. If the users respond affirmatively, a communication pathway can be opened between the user sessions 305, 310, 320 in user group 340 to facilitate real-time communications between users. In alternative arrangements, an instant messaging session or a newsgroup can be established among the user sessions 305, 310, 320, or an application can be opened which can be shared among user sessions 305, 310, 320. Further, a window can be presented to users in the user sessions 305, 310, 320 advising the users that if a specified number of users purchase item ZZ within a specified period of time, each of the users purchasing the items will receive a specified discount. Similarly, a user interface 355 can be provided in user sessions 315, 325, and a real-time communications pathway can be opened between the user sessions 315, 325.

In another example, a real-time affinity of user sessions can be determined and a user group can be formed for user sessions simultaneously accessing a particular URL having information of interest, for example a product review or a sports headline. If a minimum number of users in such user sessions are accessing the URL, each of the users can be presented a user interface offering enhanced services if a minimum number of the users agree to download a particular file, for example a product demonstration or an advertisement video. Again, a communication pathway can be opened between the users to stimulate communication between the users.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for creating user groups in a network environment comprising the steps of:
identifying at least one affinity among a plurality of user sessions; and
responsive to said affinity identification, prompting a plurality of users to engage in communication.

2. The method of claim 1, further comprising the step of monitoring said plurality of user sessions.

3. The method of claim 1, wherein said initiating step further comprises the step of providing access to an interaction application for said at least two of said plurality of user sessions responsive to said identified affinity.

4. The method of claim 3, wherein said prompting step further comprises the step of establishing a communication pathway to facilitate real time communications between users associated with said at least two user sessions.

5. The method of claim 4, wherein said step of establishing a communication pathway further comprises the step of opening at least one of a chat session, an instant messaging session, a newsgroup, and a shared application.

6. The method of claim 1, wherein said identifying step includes the step of evaluating session cookies associated with said user sessions.

7. The method of claim 1, wherein said identifying step includes the step of evaluating session objects associated with said user sessions.

8. The method of claim 7, wherein said session objects comprise at least one datum selected from the group consisting of a URL which has been accessed, an amount of time on-line, an item in a shopping cart, and a user identifier.

9. The method of claim 8, wherein said user identifier comprises at least one of a postal code, an area code, a city, a county, a state, a province, a country and a continent.

10. A method for creating user groups in a network environment comprising the steps of:
identifying at least one affinity among a plurality of user sessions; and
responsive to said affinity identification, presenting a user interface to at least one user.

11. A machine-readable storage having stored thereon a computer program having a plurality of code sections, said code sections executable by a machine for causing the machine to perform the steps of:
identifying at least one affinity among at least two of said plurality of user sessions; and
responsive to said affinity identification, prompting a plurality of users to engage in communication.

12. The machine-readable storage of claim 11, further comprising the step of monitoring said plurality of user sessions.

13. The machine-readable storage of claim 11, wherein said initiating step further comprises the step of providing access to an interaction application for said at least two of said plurality of user sessions responsive to said identified affinity.

14. The machine-readable storage of claim 13, wherein said prompting step further comprises the step of establishing a communication pathway to facilitate real time communications between users associated with said at least two user sessions.

15. The machine-readable storage of claim 14, wherein said step of establishing a communication pathway further comprises the step of opening at least one of a chat session, an instant messaging session, a newsgroup, and a shared application.

16. The machine-readable storage of claim 11, wherein said identifying step includes the step of evaluating session cookies associated with said user sessions.

17. The machine-readable storage of claim 11, wherein said identifying step includes the step of evaluating session objects associated with said user sessions.

18. The machine-readable storage of claim 17, wherein said session objects comprise at least one datum selected from the group consisting of a URL which has been accessed, an amount of time on-line, an item in a shopping cart, and a user identifier.

19. The machine-readable storage of claim 18, wherein said user identifier comprises at least one of a postal code, an area code, a city, a county, a state, a province, a country and a continent.

20. A machine-readable storage having stored thereon a computer program having a plurality of code sections, said code sections executable by a machine for causing the machine to perform the steps of:
identifying at least one affinity among a plurality of user sessions; and
responsive to said affinity identification, presenting a user interface to at least one user.

21. A system for creating user groups in a network environment comprising:
means for identifying at least one affinity among at least two of said plurality of user sessions; and
means for initiating prompting a plurality of users to engage in communication responsive to said affinity identification.

22. A system for creating user groups in a network environment comprising:
means for identifying at least one affinity among a plurality of user sessions; and
means for presenting a user interface to at least one user responsive to said affinity identification.
